(19) United States
(12) Patent Application Publication
(10) Pub. No.: US 2014/0271534 A1
(43) Pub. Date: Sep. 18, 2014

(54) COMPOUNDS, COMPOSITIONS, AND METHODS FOR REPELLING AN INSECT FROM AN AREA, ARTICLE, AND/OR STRUCTURE

(71) Applicant: BAYER CROPSCIENCE LP, Research Triangle Park, NC (US)

(72) Inventors: Tai-Teh WU, Chapel Hill, NC (US); Dick ROGERS, Chapel Hill, NC (US); Jian ZHANG, Durham, NC (US); Robert CROFT, Durham, NC (US); Chi Yu Roy CHEN, Raleigh, NC (US)

(73) Assignee: BAYER CROPSCIENCE LP, Research Triangle Park, NC (US)

(21) Appl. No.: 14/197,975

(22) Filed: Mar. 5, 2014

Related U.S. Application Data
(60) Provisional application No. 61/791,662, filed on Mar. 15, 2013.

(51) Int. Cl. A01N 35/04; A01N 35/06; A01N 65/10; A01N 43/50; A01N 31/16; A01N 31/04; A01N 43/78; A01N 25/00; A01N 65/22

(52) U.S. Cl. CPC A01N 35/04; A01N 25/002; A01N 35/06; A01N 65/10; A01N 65/22; A01N 31/16; A01N 31/04; A01N 43/78; A01N 43/50
USPC 424/84; 514/675; 424/745; 514/365; 514/341

(57) ABSTRACT

The disclosure provides for methods of repelling, directing, altering the behavior, and/or controlling an insect by utilizing a compound or composition described herein. The disclosure also provides for methods of repelling or directing an insect from an organism, article, or structure by utilizing a compound or composition described herein. The disclosure also provides for an article or structure treated with a composition including at least one repellent, controlling, or directing compound described herein.

### CROSS REFERENCE TO RELATED APPLICATION

This application claims the benefit of U.S. Provisional Application Ser. No. 61/791,662, filed Mar. 15, 2013, the content of which is herein incorporated by reference in its entirety.

### FIELD

The disclosure provides for compounds, compositions, and methods of repelling, directing, altering the behavior of, and/or controlling an insect by utilizing a compound or composition described herein. The disclosure also provides for compounds, compositions, and methods of repelling or directing an insect from an organism, article, or structure by utilizing a compound or composition described herein. The disclosure also provides for an article or structure treated with a composition including at least one repellent, controlling, or directing compound described herein.

### BACKGROUND

Insects have long presented problems to human and animal populations. Insects are known to carry various diseases and spread these diseases across both human and animal populations. The large numbers of diseases spread by insects are well documented and there have been numerous attempts at developing effective products to combat the health problems associated with insects.

Besides the serious disease causing problems attributable to insects, insects also present a general nuisance to humans attempting to engage in social as well as recreational outdoor activities. For instance, insects are a common pest at family picnics and outdoor sporting events. The nuisance of insects is also acutely felt when individuals engage in camping, hunting, and many other outdoor activities. On the other hand, many insects provide helpful and reinforced effects. For example, the honeybee serves the important function of the pollination of various plants.

Because of the problems associated with insects, many strategies have been developed in an attempt to repel or disperse insects through the use of repellants. However, many of insect repellants suffer from a number of drawbacks, including lack of efficacy over a sufficient period of time. Additionally, many insect repellents operate to repel insects generally, whereas in some cases it may be desirable to repel only selected types of insects. Therefore, there is a need to develop repellents that effectively and selectively in some cases repel insects away from undesired areas. To this end, the disclosed repelling, controlling, and directing compounds, compositions, and associated methods address these issues and have the ability to repel, control, and/or alter the behavior of insects over a longer period of time and with greater efficacy than previously recognized, and in certain embodiments, selectively repel only certain types of insects.

### SUMMARY

In an aspect, the disclosure provides for a method, compounds, or compositions of repelling or directing an insect away from an article, structure, and/or organism by treating the article, structure, and/or organism with at least one compound from Formula I-IX below. In another embodiment, the compound, composition, and/or method repels or directs at least 80% of the insects away from the structure, article, and/or organism for at least 8 hours. In another aspect, the compound, compositions, and/or methods selectively repels certain types of insects.

In another aspect, the disclosure provides for a bait composition including at least one compound from Formula I-IX.

In yet another aspect, the disclosure provides for a structure, article, and/or organism treated with at least one compound from Formula I-IX. In an aspect, the organism is a mammal, livestock, household animal, or human.

In another aspect, the repelling or directing compound described herein includes at least one C₇-C₁₅ ketone compound.

In another aspect, the C₇-C₁₅ ketone is selected from the group consisting of 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

In an aspect, the insect repelled and/or diverted is a pollinating insect and optionally a honeybee.

In an aspect, an article treated with a compound or composition described herein is formulated as a bait, bait mechanism or holder, garment, belt, air freshener, candle, fiber, bedding, sheet, cloth, clothing, a net, insect netting, fabric, paper, glass, paint, ink, clay, cotton, wood, furniture, carpet, plastic, polymer, biological or synthetic material, spray product, fogging system, foam, gel, evaporator product, granule, and dust.

In another aspect, a structure or item or article according to the disclosure include the interior or exterior of a building, the interior or exterior of a commercial building, a car, a boat, a patio, a deck, furniture, a window, a container, a container designed to hold an insect, a container designed to repel, direct, or control an insect, a trashcan or trash receptacle, an indoor space, an outdoor space, including but not limited to a field, a park area, a golf course or the like, a tree, a bush, a clover, a shrub, a flowering plant, a lawn, a shed, and any additional structure, an article, an area capable of being contacted, infested by an insect.

In yet another aspect, the disclosure provides for a composition that includes an agent selected from the group consisting of camphor, camphor oil, camphor powder, tea tree oil, essential oils of tea tree, pine oil, rosemary powder, and rosemary oil.

In an aspect, the compound or composition repels at least 95% of the insects for at least 8 hours.

### BRIEF DESCRIPTION OF THE FIGURES

FIG. 1 sets forth the feeding station arrangement for the honeybee repulsion experiment of Example 1. Panel (A) sets forth the bee cage positions on the left portion of panel (A) with the randomized feeding station positions on the right portion of panel (A). (B) sets forth an alignment of the randomized feeding station positions with a distance of two meters between feeding stations.

FIG. 2 sets forth a honeybee feeding station with a solution of 2-decanone with a 50% sucrose solution after 8 hours.

FIG. 3 sets forth a honeybee feeding station with a 50% sucrose solution after 8 hours.

FIG. 4 sets forth a side by side comparison of the repulsion characteristics of (A) 2-decanone (left panel) with a 50% sucrose solution as compared to (B) a 50% sucrose control (right panel) on honeybees after a 8 hour period of time.

FIG. 5 sets forth the number of honeybees visiting feeding stations for T1 (control), T2 (control), T3 (control), T4 (Camphor oil), T5 (Ajowan oil), T6 (Camphor powder), T7 (Rosemary oil), and T8 (2-Decanone) over a varied time period. 50% sucrose was included with T4 (Camphor oil), T5 (Ajowan oil), T6 (Camphor powder), T7 (Rosemary oil), and T8 (2-Decanone).

FIG. 6 sets forth the mean number of honeybees visiting feeding station over a period of four hours for T1 (control), T2 (control), T3 (control), T4 (Camphor oil), T5 (Ajowan oil), T6 (Camphor powder), T7 (Rosemary oil), and T8 (2-Decanone). 50% sucrose was included with T4 (Camphor oil), T5 (Ajowan oil), T6 (Camphor powder), T7 (Rosemary oil), and T8 (2-Decanone).

### DETAILED DESCRIPTION

### Insect Repellent, Controlling, or Directing Compound

The disclosure provides for an insect repelling, controlling, and/or directing compound or composition. In another aspect, a repelling, controlling, and/or directing compound or composition described herein repels all or a broad range of insects. In another aspect, a repelling, controlling, and/or directing compound or composition described herein repels some but not all insects.

In an aspect, an insect repellent, controlling, or directing compound or composition described herein can control or alter the behavior of an insect, for example a pollinating insect such as a bee. In another aspect, the disclosure provides for a repellent, controlling, and directing compound or composition and methods of repelling, controlling, or directing an insect by utilizing a compound of Formula I:

[chemical structure]

In an aspect, R₁ and R₂ are independently selected from an alkyl, aryl, phenyl, substituted phenyl, fused phenyl, heterocyclic ring, aryl alkyl, vinyl, acetyl, vinyl alky, propargyl, and ally group.

In another aspect, R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non-substituted C₂-C₁₄-alkyl, substituted or non-substituted C₂-C₁₄ alkenyl, a substituted or non-substituted C₂-C₁₄-alkynyl.

In a further aspect, R₁ is H and R₂ is an alkyl or aryl or R₁ is alkyl or aryl and R₂ is H.

In another aspect, an alkyl group is a straight chain, branched, cyclic, cyclic alkyl optionally substituted with halogen, such as F, Cl, Br, I, oxygen, hydroxyl, alkoxy, cyano, aryloxy, C═C, C≡C; nitrogen, NH2, alkyl amino, dialkyl amine trialkylamino; SH, alkylthio and oxidation states, arylthio and oxidation states; amido, monoalkylamino, dialkylamino, and ureido.

In yet another aspect, R₁ and R₂ can form a ring, such as a cycloalkyl ring, for example, a cyclehexyl, cycloheptyl, cyclopentyl, cyclopropyl, cyclobutyl, cyclooctyl, fused alkyl ring, such as camphor. In another aspect, the R₁ and R₂ ring is a phenyl ring optionally substituted with one or more of halogen, OH, alkoxy, cyano, amino alkylamino, dialkylamino, SH, alkylthio and oxidation states, pheoxy, formyl, alkylcarbonyl, alkoxycarbonyl, haloalkyl, haloalkoxy, polyhaloalkyl, polyhaloalkoxy, perhaloalkyl, perhaloalkoxy, amido, alkylamino, amino, dialkylamino, hydroxycarbonyl, alkyl carbonyl, aryl carbonyl, and alkoxycarbonyl groups.

In another aspect, R₁ and R₂ are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, and a (CH₂)₁₃ ring structure.

In yet another aspect R₁ methyl or ethyl and R₂ is selected from the group consisting of methyl, ethyl, propyl, isopropyl, cyclopropyl, butyl, iso-butyl, tert-butyl, pentyl, hexyl, heptyl, octyl, nonyl, decyl, undecyl and substituted or non-substituted C₂-C₁₄-alkyl, substituted or non-substituted C₂-C₁₄ alkenyl, a substituted or non-substituted C₂-C₁₄-alkynyl.

In an aspect, the repelling, controlling, or directing compound is represented by Formula II, where R₁ and R₂ are defined above:

[chemical structure]

In an aspect, the repelling, controlling, or directing compound is represented by Formula III, where R₁ and R₂ are defined above:

[chemical structure]

In an aspect, the repelling, controlling, or directing compound is represented by Formula IV, where R₁ and R₂ are defined above:

[chemical structure]

In an aspect, the repelling, controlling, or directing compound is represented by Formula V, where R₁ and R₂ are defined above:

[chemical structure]

In an aspect, the repelling, controlling, or directing compound is represented by Formula VI, where R₁ and R₂ are defined above:

[chemical structure]

In an aspect, the repelling, controlling, or directing compound is represented by Formula VII, where R₁ and R₂ are defined above:

[chemical structure]

In an aspect, the repelling, controlling, or directing compound is represented by Formula VIII, where R₁ and R₂ are defined above and wherein R₃ and R₄ are individually selected from H, alkyl, methyl, ethyl, propyl, or butyl. In another aspect R₃ and R₄ can be any of the above referenced alkyl groups.

[chemical structure]

In an aspect, the repelling, controlling, or directing compound is represented by Formula IX, where R₁ and R₂ are defined above:

[chemical structure]

In another aspect, the disclosure provides for optically active and/or geometric isomers and/or salts thereof of compounds of Formula I-IX. In yet another aspect, the disclosure provides for metabolites, analogues, homologues, isomers, diastereomers, conjugate isomers, tautomers, and salts thereof of compounds of Formula I-IX. In another aspect, the methodology described herein can be practiced with one or more compounds represented by Formula I-IX.

In an aspect, the insect repellent, controlling, or directing compound or composition is selected from the group consisting of a ketone, such as a C₅-C₇ ketone, C₆-C₉ ketone, C₇-C₁₀ ketone, a C₈-C₁₂ ketone, C₁-C₁₂ ketone, a C₇-C₁₅ ketone, or a methyl ketone. In another aspect, the insect repellent, controlling, or directing compound is selected from one or more of 2-pentanone, cyclopentanone, 2-pentanimine, 2-hexanone, 3-hexanone, cyclohexanone, 2-methylcyclohexanone, 3-methylcyclohexanone, 4-methylcyclohexanone, 2-heptanone, 3-heptanone, 4-heptanone, heptyl, 1-acetyl, cycloheptanone, 2-octanone, 3-octanone, cyclooctanone, 2-nonanone, cyclononanone, 2-decanone (methyl-n-octyl ketone), 2-undecanone (methyl-n-nonylketone), 2-dodecanone, 1,3-dioxolane, 2-methyl-2-octyl, 2-trideconone, 2-tetradecanone, 2-pentadecanone, 2-hexadecanone, 2-heptadecanone, 2-nonanethione, cyclodeconone, decane, 2,2-dimethoxy, sulfur analog of 2-decanone, 2-decanimine, (+)-2-decanol, 2-decanol, 2,9-decanedione, 2,11-dodecanedione, 2,5-dodecanedione, 2,2-decanediol, 1-undecen-2-ol, 3-decanone, 4-decanone, 5-decanone, 9-methyl, decanal, ethanone, 1-[3-methyl-4-(trifluoromethyl) phenyl], ethanone, 2,2,2-trifluoro-1-phenyl, 5,9-undecadien-2-one, 6,10-dimethyl-, (5E)-, 2-pentadecanone, 4-methylcyclohexanone, p-methylacetophenone, propionphenone, 2-Hydroxyacetophenone, 2,9-decanedione, 2,11-dodecanedione, 2,5-dodecanedione, and 2-hydroxy acetophenone.

In an aspect, the insect repellent, controlling, or directing compound or composition is selected from the group consisting of a compound from 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

In another aspect, a repellent, controlling, or directing compound or composition is selected from the group consisting of Table 1:

TABLE 1

| | |
|---|---|
| [chemical structure] | Compound 1 |
| [chemical structure] | Compound 2 |
| [chemical structure] | Compound 3 |
| [chemical structure] | Compound 4 |
| [chemical structure] | Compound 5 |
| [chemical structure] | Compound 6 |
| [chemical structure] | Compound 7 |
| [chemical structure] | Compound 8 |
| [chemical structure] | Compound 9 |
| [chemical structure] | Compound 10 |
| [chemical structure] | Compound 11 |
| [chemical structure] | Compound 12 |
| [chemical structure] | Compound 13 |
| [chemical structure] | Compound 14 |
| [chemical structure] | Compound 15 |
| [chemical structure] | Compound 16 |
| [chemical structure] | Compound 17 |
| [chemical structure] | Compound 18 |
| [chemical structure] | Compound 19 |
| [chemical structure] | Compound 20 |
| [chemical structure] | Compound 21 |
| [chemical structure] | Compound 22 |
| [chemical structure] | Compound 23 |
| [chemical structure] | Compound 24 |
| [chemical structure] | Compound 25 |
| [chemical structure] | Compound 26 |
| [chemical structure] | Compound 27 |
| [chemical structure] | Compound 28 |
| [chemical structure] | Compound 29 |
| [chemical structure] | Compound 30 |
| [chemical structure] | Compound 31 |
| [chemical structure] | Compound 32 |
| [chemical structure] | Compound 33 |

[chemical structure]

In an aspect, methyl ketones of C₅-C₇ have a lower repellent activity than those with C₈-C₁₂. In an aspect, by “lower” it is meant that the methyl ketones of C₅-C₇ repel, control, or direct a lower percentage of insects of interest relative to C₈-C₁₂ ketones. In another aspect, by “lower” it is meant that the methyl ketones of C₅-C₇ repel, control, or direct an insect for a shorter period of time, less insects of interest, or combinations of interest relative to C₈-C₁₂ ketones. In another aspect, the volatility of methyl ketones of C₅-C₇ is higher than that of methyl ketones of C₈-C₁₂.

In another aspect, methyl ketones of C₅-C₇ have a lower repellent activity than those with C₈-C₁₅. In another aspect, the volatility of methyl ketones of C₅-C₇ is higher than that of methyl ketones of C₈-C₁₅.

In yet another aspect, the disclosure provides for one or more of an insect repellent, controlling, or directing compound or composition selected from the group consisting of pine oil, tea tree oil, essential oil of tea tree, densifolia leaf essential oil, essential oil of ocimum santum, systox, phenol, alkaloids, carum copticum oil, propionic anhydride, butyric anhydride, methyl salicylate, 6-hexatriacontene, stenpcereol, 27,28,29-trisnor-13-15-17-meratriene, samaderine E, phenylacetaldehyde, benzaldehyde, Swertia densifolia leaf essential oil, linalool, ambrette seed oil, cascarilla bark oil, leaf oil, cascarilla bark oil, rue oil, rue flower oil, terpineol, stearic acid, hydroquinone and octadecanal, methyl anthranilate, methyl anthranilate, creosote, acetic acid and propionic acid, N,N-diethyltoluamide, dimethyl phthalate, and isopropyl cinnamate. The disclosure also provides for one or more of an insect repellent, controlling, or directing compound or compound combinations selected from the group consisting of citronella (for example, Cymbopogon spp, Cymbopogon nardus, Cymbopogon winterianus and Cymbopogon citratus), eucalyptus (Eucalyptus spp.), lemon eucalyptus (Corymbia citriodora), cinnamon (Cinnamomum verum), castor (Ricinus communis), rosemary (Rosmarinus officinalis), cedar (Cedrus spp.), peppermint (Mentha piperita), clove (Syzygium aromaticum), geranium (Pelargonium graveolens), verbena (Verbena spp., Verbena officinalis), pennyroyal (Mentha pulegium), lavender (Lavandula spp.), pine (Pinus spp.), cajeput (Melaleuca spp.; Melaleuca leucadendra), basil (Ocimum basilicum), thyme (Thymus vulgaris), pandan (Pandanus amaryllifolius), allspice (Pimenta dioica), soybean (Glycine max), garlic (Allium sativum), DEET, Picaridin, p-Mentane-3,8-diol, Permethrin, Allethrin, Metofluthrin, Geraniol, Eugenol, Cinnamaldehyde, Alkaloids, p-cymene, linalool, α-pinene, β-pinene, sabinene, myrcene, α-phellandrene, α-terpinene, α-terpineol, α-ter, limonene, 1,8-cineole, y-terpinene, terpinolene, terpinen-4-ol and α-terpineol, copticum, and Ptychotis oil.

In an aspect, the compounds and compositions described herein exhibit a synergistic influence when combined. In another aspect, compounds of Formula I-IX exhibit a synergistic influence when combined. In another aspect, compounds 1-33 in Table 1 exhibit a synergistic influence when combined. In yet another aspect, these compounds produce an additive effect.

In an aspect, the insect repelling, controlling, or directing compound or compound combination comprises, consists of, or consists essentially of any of the repellent, controlling, or directing compound or compositions described herein.

In another aspect, the disclosure provides for a composition comprising, consisting essentially of, or consisting of 2-decanone and rosemary oil. In another aspect, the disclosure provides for a composition comprising, consisting essentially of, or consisting of 2-decanone and camphor. In yet another aspect, the disclosure provides for a composition comprising, consisting essentially of, or consisting of 2-decanone, rosemary oil, and camphor. In an aspect, these compounds produce a synergistically effect. In yet another aspect, these compounds produce an additive effect.

In another aspect, the insect repellent, controlling, or directing compound or composition described herein works by influencing or altering the senses of an insect. In another aspect, the compound or composition alters the olfactory senses, sight, or other physical characteristics of an insect or combinations thereof. For example, where one compound or composition is a repelling, controlling, or directing compound or composition that operates on olfactory sense, other compound or compositions may be included or may be applied before, after, or simultaneously with the first compound or composition, that operates on the senses. These may involve compounds or compositions that direct or repel the insect based on sight (e.g., color), tactile sensations, taste, or other physical characteristics such as sound, vibrations, and combinations of any of the foregoing.

In another aspect, the insect repellent, controlling, or directing compound, compound combination, or composition does not include heptanone, 2-heptanone, compounds that mimic the activity of 2-heptonone, 2-undecanone, 2-dodecanone, 2-trideconone, N,N-diethyl-m-toluamide (“DEET), benzaldehyde, phenol, or any combination thereof.

In an aspect, the insect repellent, controlling, or directing composition includes 2-decanone and not 2-heptanone. In an aspect, the composition includes 2-decanone and not 2-undecanone. In another aspect, the composition includes 2-decanone and not 2-dodecanone. In yet another aspect, the composition includes 2-decanone and not 2-trideconone. Yet in another aspect, the composition includes 2-decanone and not 2-heptanone, 2-undecanone, 2-dodecanone, or 2-trideconone.

In an aspect, the composition does not contain a neem plant, neem part thereof, neem oil, or neem extract.

Methods of Repelling, Controlling, or Directing an Insect from a Structure, Article, or Organism

The disclosure provides for methods of repelling, controlling, or directing an insect away from a structure, organism, or article by utilizing a compound or composition described herein.

In an aspect, the disclosure provides for a method of repelling, controlling, or directing an insect away from a structure, organism, or article by treating the structure, organism, or article with a repellent, controlling, or directing compound or composition described herein.

In another aspect, the disclosure provides for a method of repelling, controlling, or directing an insect away from a structure, organism, or article by contacting, coating, or impregnating the structure, organism, or article with one or more repellent, controlling, or directing compound or composition described herein.

The disclosure also provides for a method of treating a first structure or article with a repelling, controlling, or directing compound or composition described herein and at the same or different time treating a second structure or article or portion thereof (and/or a portion of said first structure) with an insect attractant compound or composition that is, in one aspect, strategically placed at an optimized distance from the first structure or article or said portion of said first or second article or structure. Such a methodology has the ability to both repel, control, or direct an insect from a first structure or article while attracting an insect to a second structure or article or portions thereof.

The following provides a non-limiting example of such a methodology:
(1) a first “structure 1” or “article 1” or portion thereof is treated with one or more repellent, controlling, or directing compounds or compositions described herein; and
(2) a second “structure 2” or “article 2,” portions, or combinations thereof is treated with one or more repellent, controlling, or directing compounds or compositions described herein;
(3) wherein the first “structure 1” or “article 1” or portion thereof is placed at an optimized distance from the second “structure 2” or “article 2” or portion thereof.

In yet another aspect, two or more, three or more, or four or more “structures” or “articles” or portions thereof are treated with at least one repellent, controlling, or directing compounds or compositions described herein.

In yet another aspect, “structure 1” or “article 1” are a distance of about 0.1 meters, about 0.5 meters, about 1 meter, about 3 meters, about 5 meters, about 10 meters, about 25 meters, about 50 meters, about 100 meters, about 200 meters, or about 300 meters away from “structure 2” or “article 2.” In another aspect, “structure 1” or “article 1” are a distance apart that is sufficient to repel, direct, or control an insect from “structure 1” or “article 1” and attract an insect to “structure 2” or “article 2.”

In another aspect, one or more, two or more, three or more, or four or more “structures” or “articles” can be treated with one or more repellent, controlling, or directing compounds or compositions.

In an aspect, the percent of the compound on any composition or formulation is determined by the interplay of the effectiveness in the compound repellency, the medium or other components in which the compound is carried, the methods of application and the area that is being treated, when in terms of surface area or volume. For example, where the surface is a flat plate or wall, surface area may be used, and where the area is a room or other space, volume may be used to determine rates of applications.

### Method of Repelling, Controlling, or Directing an Insect

In an aspect, a compound or composition described herein repels, controls, or directs all or a broad range of an insect of interest, for instance a bee. In another aspect, a compound or composition described herein repels, controls, or directs on a selective basis. In yet another aspect, the insect may be directed by coming into contact with a compound or composition described herein. In another aspect, an insect of interest, such as a bee, in a manner such that the insect is not in direct contact with a substance treated with the repellent, controlling, or directing compound or composition. In another aspect, a compound or composition described herein repels, controls, or directs an insect of interest, such as a bee, in a manner such that the insect has only minimal contact with a treated substance.

In another aspect, a compound or composition described herein repels, controls, or directs an insect of interest such that the insect is not in direct contact for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more with a treated substance, such as a structure, article, or organism. In yet another aspect, a compound or composition described herein repels, controls, or directs an insect of interest such that the insect is not in direct contact with a treated substance for a specified time, for example, a planting, growing, or harvesting season.

In another aspect, a compound or composition described herein repels, controls, or directs an insect of interest such that the insect is at least about 1 cm, at least about 5 cm, at least about 10 cm, at least about 100 cm, at least about 0.2 meters, at least about 0.5 meters, at least about 1 meter, at least about 2 meters, at least about 5 meters, at least about 10 meters, at least about 25 meters, at least about 50 meters, at least about 100 meters, at least about 200 meters, or at least about 300 meters or more away from a treated substance, such as a structure, article, or organism. In yet another aspect, a compound or composition described herein repels, controls, or directs an insect of interest such that the insect is at least about 1 cm, at least about 5 cm, at least about 10 cm, at least about 100 cm, at least about 0.2 meters, at least about 0.5 meters, at least about 1 meter, at least about 2 meters, at least about 5 meters, at least about 10 meters, at least about 25 meters, at least about 50 meters, at least about 100 meters, at least about 200 meters, or at least about 300 meters or more away from a treated substance, such as a structure, article, or organism, for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more, or a designated time frame, or growing season.

In another aspect, a compound or composition described herein repels, controls, or directs an insect of interest such that the insect is at least about 1 cm to about 10 cm, about 10 cm to about 100 cm, about 100 cm to about 500 cm, about 1 meter to about 5 meters, about 5 meters to about 10 meters, about 10 meters to about 50 meters, about 50 meters to about 100 meters, about 100 meters to about 250 meters, and about 250 meters to about 500 meters or more away from a treated substance, such as a structure, article, or organism. In yet another aspect, a compound or composition described herein repels an insect of interest such that the insect is at least about 1 cm to about 10 cm, about 10 cm to about 100 cm, about 100 cm to about 500 cm, about 1 meter to about 5 meters, about 5 meters to about 10 meters, about 10 meters to about 50 meters, about 50 meters to about 100 meters, about 100 meters to about 250 meters, and about 250 meters to about 500 meters or more away from a treated substance, such as a structure, article, or organism for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, or about 3 months or more, or a designated growing season.

In another aspect, a compound or composition described herein controls or directs an insect of interest, such as a bee, for at least about 10 minutes, about 30 minutes, about 1 hour, about 4 hours, about 8 hours, about 12 hours, about 24 hours, about 2 days, about 3 days, about 7 days, about 14 days, about 21 days, about 1 month, about 2 months, about 3 months or more, or a designated time frame or growing or harvesting season.

In another aspect, one or more additional repellent, controlling, or directing compounds or compositions can be added to a repellency composition described herein in a manner that modifies or increases repellency via additive efforts, synergistic efforts, and combinations thereof. A compound or composition described herein can also be formulated in a delayed release formulation or controlled release formulation which can delay or control the release of the repellent compound or composition. In another aspect, a compound or composition described herein can also be formulated in a rapid release formulation which can expedite the release of the repellent compound or composition.

In an aspect, a method of “repelling” refers to the ability of a compound or composition described herein to influence or alter the behavior of an insect, for example, a bee, away from an area, location, structure, article, or substance of interest. In order to be classified as “repelling” according to an aspect of the disclosure, it is not necessary that 100% of the insects be directed away from an area, mammal, location, structure, article, or substance of interest. In yet another aspect, an insect is “repelled” if at least 50%, at least 75%, at least 90%, at least 95%, or at least 98% of the insects are directed away from an area, organism, location, structure, article, or substance of interest.

In another aspect, a method of “directing” refers to the ability of a compound or composition described herein to influence the behavior or movement of an insect, for example a bee, in a given direction. In order to be classified as “directing” according to an aspect of the disclosure, it is not necessary that 100% of the insects be directed away from an area, mammal, location, structure, article, or substance of interest. In yet another aspect, an insect is “directed away” if at least 50%, at least 75%, at least 90%, at least 95%, or at least 98% of the insects are directed away from an area, organism, location, structure, article, or substance of interest.

In an aspect, a method of “controlling” refers to the ability of a compound or composition described herein to control or alter the behavior of an insect, for example a bee. In order to be classified as “controlling” according to an aspect of the disclosure, it is not necessary that 100% of the insects are controlled relative to an area, mammal, location, structure, article, or substance of interest. In yet another aspect, an insect is “controlled” if at least 50%, at least 90%, at least 95%, or at least 98% of the insect behavior is altered or controlled relative to an area, mammal, location, structure, article, or substance of interest.

### Structure, Article, Organism, and Livestock

a. Structure

In an aspect, a compound or composition described herein has the ability to repel or direct an insect away from a structure. Without being limited, a “structure” is an area or locus capable of contacting or being infested by an insect. In another aspect, a “structure” can be man-made or naturally occurring. Without being limited, a “structure” can be a building, for example a commercial or residential building, the interior or exterior of a building, an outdoor space, including but not limited to a field, a park area, a golf course or the like, a car, a boat, a patio, a deck, a table, a chair, a window, a container, a container designed to hold an insect, a container designed to repel, direct, or control an insect, a trashcan or a trash receptacle, an indoor space, such as a room in a commercial or residential building, an outdoor space, or structures oftentimes present in an outdoor space, such as a tree, a bush, a clover, a shrub, a flowering plant, a lawn, a shed, or other such structure.

b. Article

In an aspect, a compound or composition described herein has the ability to repel or direct an insect away from an article. Without being limited, an “article” is an element that is capable of being contacted, influenced, or infested by an insect. In another aspect, without being limited, an “article” can be bait, a bait mechanism or holder, a device, garment, belt, air freshener, candle, other scented article, fiber, bedding, sheet, cloth, clothing, net, insect netting, fabric, paper, glass, paint, ink, clay, cotton, woods, furniture, carpet, sanitary good, plastic, polymer, biological or synthetic material, spray product, fogging system, fogger, foam, gel, evaporator product, evaporator system, granule, or dust.

In another aspect, an article may be treated, coated, sprayed with, or impregnated with a compound or composition described herein.

c. Organism

In an aspect, an organism is an animal or a human. In another aspect, a compound or composition described herein has the ability to repel or direct an insect away from an organism, for example, an animal or a human. In another aspect, a compound or composition described herein has the ability to control the behavior of insects in areas containing animals or a human. In an aspect, a compound or composition described herein can be utilized in any application that reduces bee-human interaction or a bee-location interaction. In another aspect, a compound or composition described herein may be administered to an individual or location alone, or in combination with other supplementary active ingredient, agent, or drug.

d. Livestock

In another aspect, livestock can be treated with an insect repellent, controlling, or directing compound or composition described herein. In an aspect and without being limited, a compound or composition described herein can be used to repel, control, or direct insects in contact with or close to livestock. In another aspect, “livestock” can include any animal capable of being infested by an insect, for example, cattle, sheep, goats, horses, pigs, rabbits, chickens, turkeys, ducks, geese, and domestic animals, such as dogs, cats, caged birds, hamsters, guinea pigs, rats, and mice.

### Treatment of a Structure, Article, and Organism

In an aspect, a compound or composition described herein is applied to all or a portion of a structure, article, or organism in a single application step. In another aspect, a composition described herein is applied to all or a portion of a structure, article, or organism in multiple application steps, for example, two, three, four, five, or more application steps. In another aspect, the second, third, fourth, or fifth or more application steps may be with the same or different compositions.

In another aspect, a compound or composition described herein is applied to all or a portion of a structure, article, or organism in a manner that is sufficient to repel, control, or direct an insect.

In another aspect, a compound or composition described herein is applied to all or a portion of a structure or article during, or after insect infestation occurs. In yet another aspect, a compound or composition described herein is applied to all or a portion of a structure or article before, during, and after infestation occurs or additional combinations thereof. In another aspect, a compound or composition described herein is applied to all or a portion of a structure, article, or organism when necessary and, for example, in intervals of about 5 minutes, about 15 minutes, about 30 minutes, about 1 hour, about 2 hours, about 6 hours, about 8 hours, about 12 hours, about 1 day, about 5 days, about 7 days, about 10 days, about 12 days, about 14 days, about 21 days, about 28 days, about 1 month, about 2 months, about 3 months, or each season until the insects are repelled or insect infestation is treated or abated. In yet another aspect, a compound or composition described herein is applied to all or a portion of a structure, article, or organism in intervals of about 30 minutes to about 1 hour, about 2 hours to about 4 hours, about 4 hours to about 12 hours, about 1 hour to about 1 day, about 1 day to about 5 days, about 5 days to about 10 days, about 10 days to about 20 days, about 15 days to about 30 days, about 30 to about 100 days, or in regular intervals during a given season until the insects are repelled or insect infestation is treated or abated.

### Repellent, Controlling, and Directing Compound and Composition Properties

In an aspect, a repellent, controlling, or directing compound or composition described herein is capable of repelling, controlling, or directing an insect described herein away from a structure, article, or organism for at least about 10 minutes, about 30 minutes, about 1 hour, about 2 hours, about 3 hours, about 4 hours, about 8 hours, about 10 hours, about 15 hours, about 24 hours, about 48 hours, about 72 hours, about 7 days, about two weeks, about one month, about two months, about three months or more.

In another aspect, a repellent, controlling, or directing compound or composition described herein repels, controls, or directs an insect by at least about 20% or more, about 30% or more, about 40% or more, about 50% or more, about 60% or more, about 75% or more, about 90% or more, about 95% or more, about 98% or more, or about 99% or more relative to a compound or composition that does not contain an effective amount of a repellent, controlling, or directing compound or composition described herein. In another aspect, a repellent, controlling, or directing compound or composition described herein repels, controls, or directs an insect by at least about 20% or more, about 30% or more, about 40% or more, about 50% or more, about 60% or more, about 75% or more, about 90% or more, about 95% or more, about 98% or more, or about 99% or more for at least about 5 minutes, about 10 minutes, about 30 minutes, about 1 hour, about 2 hours, about 3 hours, about 4 hours, about 8 hours, about 10 hours, about 15 hours, about 24 hours, about 48 hours, about 72 hours, about 7 days, about two weeks, about one month, about two months, about three months or more, or during a complete or partial season relative to a compound or composition that does not contain an effective amount of a repellent, controlling, or directing compound or composition described herein. In yet another aspect, a repellent, controlling, or directing compound or composition described herein repels or controls an insect, for example a bee, by at least 95% or more, 96% or more, 97% or more, 98% or more, 99% or more, or 100% for at least about 5 minutes, about 10 minutes, about 30 minutes, about 1 hour, about 2 hours, about 3 hours, about 4 hours, about 8 hours, about 10 hours, about 15 hours, about 24 hours, about 48 hours, about 72 hours, about 7 days, about two weeks, about one month, about two months, about three months or more, or a designated time period, for example, during a complete or partial season relative to a compound or composition that does not contain an effective amount of a repelling, controlling, or directing compound or composition described herein.

In yet another aspect, a repellent, controlling, or directing compound or composition described herein repels, controls, or directs an insect by about 10% to about 100%, about 20% to about 100%, about 30% to about 100%, about 40% to about 100%, about 50% to about 100%, about 60% to about 100%, about 70% to about 100%, about 80% to about 100%, about 10% to about 90%, about 20% to about 90%, about 30% to about 90%, about 40% to about 90%, about 50% to about 90%, about 60% to about 90%, about 70% to about 90%, about 10% to about 80%, about 20% to about 80%, about 30% to about 80%, about 40% to about 80%, about 50% to about 80%, or about 60% to about 80%, about 10% to about 70%, about 20% to about 70%, about 30% to about 70%, about 40% to about 70%, or about 50% to about 70%, relative to a compound or composition that does not contain an effective amount of a repelling, controlling, or directing compound or composition described herein.

In an aspect, a repelling, controlling, or directing compound or composition disclosed herein reduces insect interaction with a mammal, structure, and/or article. In an aspect, a repelling, controlling, or directing compound or composition described herein is capable of reducing the interaction of an insect with structure, article, and/or organism for at least about 5 minutes, about 10 minutes, about 30 minutes, about 1 hour, about 2 hours, about 3 hours, about 4 hours, about 8 hours, about 10 hours, about 15 hours, about 24 hours, about 48 hours, about 72 hours, about 7 days, about two weeks, about one month, about two months, about three months or more, or a designated time frame, for example, a growing or harvesting season. In another aspect, a repelling, controlling, or directing compound or composition described herein is capable of reducing the interaction of an insect with a mammal, structure, and/or article by at least about 20% or more, about 30% or more, about 40% or more, about 50% or more, about 60% or more, about 75% or more, about 90% or more, about 95% or more, about 98% or more, or about 99% or more relative to a compound or composition that does not contain an effective amount of a repellent, controlling, or directing compound or composition described herein. In another aspect, a repelling, controlling, or directing compound or composition described herein reduces the interaction of an insect, for example a bee, with a mammal, structure, and/or article by at least about 20% or more, about 30% or more, about 40% or more, about 50% or more, about 60% or more, about 75% or more, about 90% or more, about 95% or more, about 98% or more, or about 99% or more for at least about 5 minutes, about 10 minutes, about 30 minutes, about 1 hour, about 2 hours, about 3 hours, about 4 hours, about 8 hours, about 10 hours, about 15 hours, about 24 hours, about 48 hours, about 72 hours, about 7 days, about two weeks, about one month, about two months, about three months or more relative to a compound or composition that does not contain an effective amount of a repelling, controlling, or directing compound or composition described herein. In yet another aspect, a repelling, controlling, or directing compound or composition described herein reduces the interaction of an insect with a structure, article, and/or organism by at least 95% or more, 96% or more, 97% or more, 98% or more, 99% or more, or 100% for at least about 5 minutes, about 10 minutes, about 30 minutes, about 1 hour, about 2 hours, about 3 hours, about 4 hours, about 8 hours, about 10 hours, about 15 hours, about 24 hours, about 48 hours, about 72 hours, about 7 days, about two weeks, about one month, about two months, about three months or more, or a designated time frame, for example, a growing season, relative to a compound or composition that does not contain an effective amount of a repellent, controlling, or directing compound or composition described herein.

In an aspect, a repellent, controlling, or directing compound or composition disclosed herein exhibits a larger repellent influence relative to one or more of the following: camphor oil, ajowan oil, camphor powder, or rosemary oil. In yet another aspect, 2-decanone, a repellent compound or composition disclosed herein exhibits a larger repellent effect relative to one or more of the following: camphor oil, ajowan oil, camphor powder, or rosemary oil in a manner that is consistent with the examples and FIGS. 5-6.

In yet another aspect, a repelling, controlling, or directing compound or composition disclosed herein exhibits a larger repellent, controlling, or directing influence relative to one or more of the following: camphor oil, ajowan oil, camphor powder, or rosemary oil for at least about 5 minutes, about 10 minutes, about 30 minutes, about 1 hour, about 2 hours, about 3 hours, about 4 hours, about 8 hours, about 10 hours, about 15 hours, about 24 hours, about 48 hours, about 72 hours, about 7 days, about two weeks, about one month, about two months, about three months or more. In another aspect, a repelling, controlling, or directing compound or composition disclosed herein exhibits increased repellency, controlling, or directing efficacy for at least about 20% or more, about 30% or more, about 40% or more, about 50% or more, about 60% or more, about 75% or more, about 90% or more, about 95% or more, about 98% or more, or about 99% or more relative to one or more of the following: camphor oil, ajowan oil, camphor powder, oil rosemary oil. In another aspect, a repelling, controlling, or directing compound or composition disclosed herein exhibits increased repellency, controlling, or directing efficacy for at least about 20% or more, about 30% or more, about 40% or more, about 50% or more, about 60% or more, about 75% or more, about 90% or more, about 95% or more, about 98% or more, or about 99% or more for at least 30 minutes, 1 hour, 2 hours, 3, hours, 4 hours, 5 hours, 10 hours, 15 hours, 20 hours, 24 hours, 48 hours, 72 hours, 7 days, two weeks, one month or more relative to relative to one or more of the following: camphor oil, ajowan oil, camphor powder, rosemary. In yet another aspect, a repellent, controlling, or directing compound or composition reduces an ability of an insect, for example a bee, to obtain a meal and/or nectar from a plant for at least 95% or more, 96% or more, 97% or more, 98% or more, 99% or more, or 100% for at least 30 minutes, 1 hour, 2 hours, 3, hours, 4 hours, 5 hours, 10 hours, 15 hours, 20 hours, 24 hours, 48 hours, 72 hours, 7 days, two weeks, one month or more relative to a compound or composition that does not contain an effective amount of a repelling, controlling, or directing compound or composition described herein.

In an aspect, a repellent, controlling, or directing compound or composition disclosed herein may be more stable (and/or less volatile) than a C₆-C₉ ketone, C₇-C₁₀ ketone, a C₈-C₁₂ ketone, 2-heptanone, 2-undecanone, 2-dodecanone, or 2-trideconone.

In additional aspects, a repellent, controlling, or directing compound or composition described herein has a half-life of about 4 hours, about 8 hours, about 12 hours, about one day, about three days, about five days, about one week, about two weeks, about three weeks, about one month, about two months, or about three months. In another aspect, a repelling, controlling, or directing compound or composition described herein has a half-life of about 4 hours, about 8 hours, about 12 hours, at least one day, at least three days, at least five days, at least one week, at least two weeks, at least three weeks, at least one month, at least two months, or at least three months. In yet another aspect, a repellent, controlling, or directing compound or composition described herein has a half-life of about 4 hours, about 8 hours, about 12 hours, to one day, about one day to about seven days, about three days to about seven days, about five days to about seven days, about one week to about four weeks, about two weeks to about four weeks, about three weeks to about four weeks, about one month to about four months, about two months to about four months, or about three months to about four months.

### Insects

In an aspect, the insect can be a pollinating insect. In another aspect, the insect is a repelled, controlled, or directed non-pollinating insect.

In an aspect, the insect is of the order Order Hymenoptera. In yet another aspect, the insect is a bee. In another aspect, the bee is a honey bee (Apis). In another aspect, the bee is a European honey bee (Apis mellifera) or Africanized honey bee. Examples of common bees are bumble bees (Bomzbus), small carpenter bees (Ceratina), large carpenter bees (Xylocopa), paper wasps (Polistes), yellow jackets (Vespula), and baldfaced hornets (Vespula). As used herein, the term “honey bee” can refer to any member of the Order Hymeoptera, Family Apidae, and includes, without limitation, Apis andreniformis, Apis cerana, Apis dorsata, Apis florae, Apis mellifera, Apis koschevnikovi, Apis laboriosa, Apis nigrocincta, Apis rorea, subspecies thereof, and strains, varieties, and hybrids thereof.

In yet another aspect, the insect is a butterfly. Butterflies are insects of the Order Lepidoptera. In an aspect, a butterfly is a true butterfly (superfamily Papilionoidea), a skipper (superfamily Hesperioidea), or a moth-butterflies (superfamily Hedyloidea). Examples of common butterflies are Swallowtails and Birdwings (Family Papilionidae) such as Common Yellow Swallowtail (Papilio machaon), Spicebush Swallowtail (Papilio Troilus), Lime Butterfly (Papilio demoleus), the Ornithoptera genus, the Whites and Yellows (Family Pieridae), such as Small White (Pieris rapae), Green-veined White (Pieris napi), Common Jezebel (Delias eucharis), the Blues and Coppers or Gossamer-Winged Butterflies (Family Lycaenidae) such as Red Pierrot (Talicada nyseus), Metalmark butterflies (Family Riodimidae) such as Duke of Burgundy (Hamearis lucina), Plum Judy, (Abisara echerius), the Brush-footed butterflies (Family Nymphalidae) such as Painted Lady, or Cosmopolitan (Vanessa cardui), Monarch butterfly (Danaus plexippus), Morpho genus, Speckled Wood (Pararge aegeria), Skippers (Family Hesperiidae) such as Mallow Skipper (Carcharodus alceae), and Zabulon Skipper (Poanes zabulon).

In another aspect, an insect described herein is an ant. In yet another aspect, the ant is a carpenter ant, a fire ant, a pharaoh ant, a ghost ant, and a black ant.

The disclosure refers to “insects” for simplicity of discussion, but it is to be understood that the present is not so limited. The present disclosure may be utilized to selectively direct, repel and/or control any organism that responds to the compounds or compositions of the present invention, and to any analogues or similar compounds and/or composition thereof that may be expected to have a similar influence on the insect or other organism. Also, the discussion in many cases hereinafter will refer to an “insect of interest” and, unless otherwise clear from the context of its use elsewhere herein, the phrase will be used to refer to the aspect of the present invention that allows for selective controlling, directing or repelling a particular subset of insects or other organisms. In other words, where the user of the present invention desires to control, direct or repel a subset of organisms such as insects, while not directing, controlling or repelling others, the subset of insects being controlled, directed and/or repelled becomes and is referred to as the “insect(s) of interest.”

In another aspect, a compound or composition described herein selectively repels, directs, controls, or alters the behavior of one type or subset of insects, for example a bee, while not affecting other insects. For instance, in one embodiment, a repelling, controlling, or directing compound or composition is associated with an insecticidal composition, for example, by a combination of the repelling, controlling, or directing compound or composition together with an insecticidal composition. In another aspect, a repelling, controlling, or directing compound or composition is sequentially applied at the same time, prior to, or after an insecticidal composition to, for example, an area, seed, plant part, or plant. In yet another aspect, an attractant compound or composition is applied to a different area or substance aimed at attracting an insect of interest.

As a non-limiting example, (1) 2-decanone as the repelling, controlling, or directing compound is used to treat field, yard, or structure, (2) clothianidin as the insecticidal compound, and (3) sucrose as the attractant compound or composition are used to treat a field, yard, or structure. As an example, all or a first portion of a field, yard, or structure is treated with (1) 2-decanone and (2) clothianidin, while the remaining section of the field, yard, or structure or a second or more portion of a field, yard, or structure is treated with an attractant compound or composition, such as (3) sucrose. Under such a scenario, an insect that is targeted for repelling, controlling, or directing, such as a honeybee, would be selectively repelled, controlled, or directed by the repelling, controlling, or directing compound, in this case the (1) 2-decanone and (2) clothianidin composition/combination, while being simultaneously attracted or drawn to the attractant compound or composition, in this case (3) sucrose. Such a procedure would allow for the selective repulsion or control of an insect of interest, for example a honeybee, while at the same time allowing for the insecticide, in this case clothianidin, to treat any unwanted insects or pests. As such, the honeybee would be selectively repelled, controlled, or directed away from the (1) 2-decanone and (2) clothianidin composition/combination, drawn to the (3) sucrose, while the infestation of any remaining insects or pests is addressed.

In yet another aspect, a compound or composition described herein selectively repels, directs, or controls, or alters the behavior of a honey bee, for example, any member of the Order Hymeoptera, Family Apidae, and includes, without limitation, Apis andreniformis, Apis cerana, Apis dorsata, Apis florae, Apis mellifera, Apis koschevnikovi, Apis laboriosa, Apis nigrocincta, Apis rorea, subspecies thereof, and strains, varieties, and hybrids thereof.

In another aspect, compound or composition described herein selectively repels any of the insects described herein. In another aspect, a compound or composition described herein selectively repels some insects, but not others.

### Compositions

In an aspect, the amount of a repellent, controlling, or directing compound or composition described herein can be present in an amount that is effective (“effective amount”) to repel, control, or direct the movement of an insect of interest. In another aspect, the amount of a repellent, controlling, or directing compound or composition described herein can be an amount that is effective to repel, control, or direct an insect away from a structure, article, or organism.

In another aspect, a composition comprises a repelling, controlling, or directing compound or composition in at least about 0.01%, at least about 0.025%, at least about 0.05%, at least about 0.1%, at least about 0.25%, at least about 0.5%, at least about 1%, at least about 2% at least about 2.5%, at least about 5%, at least about 7.5%, at least about 10%, at least about 25%, or at least about 50%, by weight of a composition. In yet another aspect, a composition comprises a repellent, controlling, or directing compound or composition in no more than about 0.01%, no more than about 0.025%, no more than about 0.05%, no more than about 0.1%, no more than about 0.25%, no more than about 0.5%, no more than about 1%, no more than about 2.0%, no more than about 2.5%, no more than about 5%, no more than about 7.5%, no more than about 10%, no more than about 25%, no more than about 50%, by weight of a composition.

In another aspect, a composition comprises a repelling, controlling, or directing compound or composition at 0.001% to about 0.1%, about 0.025%, about 0.0025% to about 0.25%, about 0.1% to about 1%, about 0.1% to about 2.5%, about 0.5% to about 2.5%, about 1% to about 2%, about 1% to about 3%, about 1% to about 5%, about 1% to about 10%, about 2% to about 10%, about 5% to about 10%, about 5% to about 20%, about 10% to about 25%, about 10% to about 50%, about 25% to about 50%, or about 20% to about 80%, and about 95% or more by weight of a composition.

In another aspect, a composition described herein comprises a compound described herein in at least about 0.01%, at least about 0.025%, at least about 0.05%, at least about 0.1%, at least about 0.25%, at least about 0.5%, at least about 1%, at least about 2% at least about 2.5%, at least about 5%, at least about 7.5%, at least about 10%, at least about 25%, or at least about 50%, by weight of a composition. In yet another aspect, a composition comprises compound described herein in an amount that is no more than about 0.01%, no more than about 0.025%, no more than about 0.05%, no more than about 0.1%, no more than about 0.25%, no more than about 0.5%, no more than about 1%, no more than about 2.0%, no more than about 2.5%, no more than about 5%, no more than about 7.5%, no more than about 10%, no more than about 25%, no more than about 50%, by weight of a composition.

In yet another aspect, a composition described herein comprises a compound described herein at 0.001% to about 0.1%, about 0.025%, about 0.0025% to about 0.25%, about 0.1% to about 1%, about 0.1% to about 2.5%, about 0.5% to about 2.5%, about 1% to about 2%, about 1% to about 3%, about 1% to about 5%, about 1% to about 10%, about 2% to about 10%, about 5% to about 10%, about 5% to about 20%, about 10% to about 25%, about 10% to about 50%, about 25% to about 50%, or about 20% to about 80%, and about 95% or more by weight of a composition.

In another aspect, a compound or composition described herein is applied to a “structure” or “article” until it is wet or saturated. In another aspect, a compound or composition described herein is applied to a “structure” or “article” in a liquid application in of about 0.1 mg/L-about 20 mg/L, about 0.1 mg/L-about 50 mg/L, about 1 mg/L-about 20 mg/L, about 5 mg/L-about 50 mg/L, about 10 mg/L-about 40 mg/L, about 10 mg/L-about 30 mg/L, about 10 mg/L-about 50 mg/L, about 5 mg/L, about 10 mg/L, about 10 mg/L, about 20 mg/L, about 30 mg/L, about 40 mg/L, about 50 mg/L, or about 100 mg/L or more.

In an aspect, a repellent, controlling, or directing compound or composition described herein can be used in conjunction with another active agent, for example, a insecticidal, herbicidal and/or fungicidal treating agent.

In an aspect, the disclosure provides for a composition comprising, consisting of, or consisting essentially of, one or more repellent, controlling, or directing compounds or compositions disclosed herein. In another aspect, the disclosure provides for a composition comprising, consisting of, or consisting essentially of a, single repelling, controlling, or directing compound or composition disclosed herein. In yet another aspect, the disclosure provides for a composition comprising, consisting of, or consisting essentially of two, three, four, or five or more repelling, controlling, or directing compounds or compositions. In another aspect, the disclosure provides for a composition comprising, consisting of, or consisting essentially of no more than two, no more than three, no more than four, or no more than five or more repelling, controlling, or directing compounds or compositions.

### Formulations

Compounds and compositions described herein may be formulated and packaged so as to deliver the product in a variety of forms including as a solution, suspension, cream, ointment, gel, film or spray, depending on the preferred method of use.

In a non-limiting aspect, compositions according to the disclosure may be formulated and used in various forms, such as aerosol dispenser, bait (ready for use), bait concentrate, block bait, capsule suspension, cold fogging concentrate, dustable powder, emulsifiable concentrate, emulsion oil in water, emulsion water in oil, encapsulated granule, fine granule, grain bait, granular bait, granule, macrogranule, microgranule, oil dispersible powder, oil miscible flowable concentrate, oil miscible liquid, paste, plate bait, scrap bait, smoke candle, smoke cartridge, smoke generator, smoke pellet, smoke rodlet, smoke tablet, smoke tin, soluble concentrate, soluble powder, suspension concentrate, oil dispersable or suspension in oil, tracking powder, ultra-low volume (ulv) liquid, ultra-low volume (ulv) suspension, vapour releasing product, water dispersible granules or tablets, water dispersible powder for slurry treatment, water soluble granules or tablets, or water soluble powder for seed treatment and wettable powder or any other forms of slow release/controlled release formulations. Additional formulations are also contemplated, for example, those described in U.S. Patent Application No. 2006/0223878, which is hereby incorporated by reference in its entirety.

In another aspect, a compound or composition described herein can take any of a variety of dosage forms including, without limitation, suspension concentrates, aerosols, capsule suspensions, cold-fogging concentrates, warm-fogging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspoemulsion concentrates, soluble concentrates, suspensions, wettable powders, soluble powders, dusts and granules, water-soluble granules or tablets, water-soluble powders for the treatment of seed, wettable powders, natural products and synthetic substances impregnated with a compound or composition described herein, a net impregnated with a compound or composition described herein, and also microencapsulations in polymeric substances and in coating materials for seed, and also ULV cold-fogging and warm-fogging formulations. Additional formulations are also contemplated, for example, those described in U.S. Patent Application No. 2006/0223878, which is hereby incorporated by reference in its entirety.

In another aspect, a compound or composition described herein is formulated as a topical composition, for example, cologne, sunscreen, lotion, spray, cream, gel, ointment, foam product, soap composition, for example, hand soap and bath/shower soap. In an aspect, desirable properties of a topical insect repellent article include low toxicity, resistance to loss by water immersion or sweating, low or no odor, ease of application, rapid formation of a dry tack-free surface film on the host's skin. In another aspect, a compound or composition described herein is designed to disperse the article into the air or disperse a compound or composition as a liquid mist or fine dust. Additionally, directly spreading of the liquid/semi-solid/solid repellent article on the host is an effective method of contacting the surface of the host with an effective amount of the repellent composition.

In another aspect, a compound or composition disclosed herein may optionally include one or more additional compounds providing an additional beneficial or otherwise useful effect. Such compounds include, without limitation, an adhesive, a solvent, a wetting agent, an emulsifying agent, a carrier, an adjuvant, a diluent, a dispersing agent an insecticide, a pesticide, a fungicide, a fertilizer of a micronutrient or macronutrient nature, a herbicide, a feeding inhibitor, an insect molting inhibitor, an insect mating inhibitor, an insect maturation inhibitor, a nematocide, a nutritional or horticultural supplement, or any combination thereof. In an aspect, a composition described herein is odor free.

In another aspect, compounds or compositions described herein can be combined with a fertilizer. Examples of fertilizers capable of being used with the compositions and methods described herein include, for example, Urea, Ammonium Nitrate, Ammonium Sulfate, Calcium Nitrate, Diammonium Phosphate, Monoammonium phosphate, Triple Super Phosphate, Potassium Nitrate, nitrate of potash, Potassium Chloride, muriate of potash, di and mono potassium salts of phosphite/phosphonate.

In an aspect, a repelling, controlling, or directing compound described herein is formulated as follows:

TABLE 2
Repelling, Controlling, or Directing Compound Alone

| | | | | |
|---|---|---|---|---|
| 1 | EC Formulation | Compound | Surfactant | |
| 2 | EC Formulation | Compound | Surfactant | Water |

Compound + Solid Carrier

| | | | | | | | |
|---|---|---|---|---|---|---|---|
| 3 | WP Formulation | Compound | Attagel/Silica | Surfactant/ | Dispersant | | |
| | | | | wetter | | | |
| 4 | SC Formulation | Compound | Attagel/Silica | Surfactant/ | Dispersant | Water | |
| | | | | wetter | | | |
| 5 | SC Formulation | Compound | Attagel/Silica | Surfactant/ | Dispersant | Water | Salt |
| | | | | wetter | | | |

Compound + Solid Carrier + Wax (Encapsulated or Controlled Release)

| | | | | | | | |
|---|---|---|---|---|---|---|---|
| 6 | WP Formulation | Compound | Attagel/Silica/ | Surfactant/ | Dispersant | | |
| | | | Wax | wetter | | | |
| 7 | SC Formulation | Compound | Attagel/Silica/ | Surfactant/ | Dispersant | Water | |
| | | | Wax | Wetter | | | |
| 8 | SC Formulation | Compound | Attagel/Silica/ | Surfactant/ | Dispersant | Water | Salt |
| | | | Wax | wetter | | | |
| 9 | WP Formulation | Compound/Wax | Attagel/Silica | Surfactant/ | Dispersant | | |
| | | | | wetter | | | |
| 10 | SC Formulation | Compound/Wax | Attagel/Silica | Surfactant/ | Dispersant | Water | |
| | | | | Wetter | | | |
| 11 | SC Formulation | Compound/Wax | Attagel/Silica | Surfactant/ | Dispersant | Water | Salt |
| | | | | wetter | | | |

EC—Emulsion concentrate; WP—Wettable Powder; SC—Suspension Concentrate; “Compound” refers to repelling, controlling, or directing compound

### Bait or Bait Device

The disclosure also provides for bait composition comprising a compound or composition described herein. In another aspect, the disclosure provides for bait composition comprising a repelling, controlling, or directing compound or composition described herein. The bait composition comprising a repelling, controlling, or directing compound or composition described herein and may be used in any of the methods described herein and may optionally include another active ingredient, such as an insecticide, herbicide, or pesticide.

In another aspect, the disclosure provides a method of treating, repelling, directing, or controlling insect infestation by adding at least one (1) compound or composition described herein and (2) bait material to a support material, detection device, or trap and placing the support material, device, or trap in an area prone to insect infestation. In another aspect, the support material, detection device, or trap is placed in an area after identification of insect infestation. In yet another aspect, the support material, detection device, or trap is placed in an area prior to identification of insect infestation.

In an aspect, an insect repellent, controlling, or directing compound or composition is combined with a compound or composition that alters the olfactory senses, sight, chemosensory senses, or other physical characteristics of an insect. In another aspect, an insect repellent compound or compound described herein can be combined with a compound or composition that alters the behavior of an insect by color, taste, or additional feature that has the ability to influence the senses of an insect. Such compositions may be added to a bait composition.

### Controlled Release, Extended Release, Rapid Release and Multi-Coating Release Formulations

In another aspect, a compound or composition described herein can be formulated in a controlled-release, extended-release, rapid release formulation or combinations thereof. In another aspect, a compound or composition described herein can be formulated in a multi-coating or multi-layer formulation. The disclosure also provides for a formulation designed to release a compound or composition disclosed herein over a period of about 5 minutes, about 15 minutes, about 30 minutes, about 1 hour, about 2 hours, about 6 hours, about 12 hours, about 24 hours, about 3 days, about 5 days, about 7 days, about 15 days, about 30 days, about 45 days, about 60 days, about 75 days, or about 90 days in single or multiple release time points. In another aspect, the disclosure also provides for a formulation designed to release a compound or composition disclosed herein over a period of about 30 minutes to about 1 hour, about 1 hour to about 6 hours, about 6 hours to about 12 hours, about 24 hours to 2 days, about 1 to about 7 days, about 7 days to about 15 days, about 10 days to about 30 days, or about 30 days to about 60 days or more.

In an aspect, a rapid-release layer or coating releases a compound immediately, after about 1 minute, after about 5 minutes, after about 15 minutes, after about 30 minutes, after about 1 hour, or after about 2 hours. In another aspect, a controlled release layer or coating releases a compound after about 3 hours, after about 6 hours, after about 12 hours, or after about 18 hours. In another aspect, an extended-release or delayed-release layer or coating releases a compound after about 1 day, after about 2 days, after about 3 days, after about 7 days, or after about 14 days or more.

Formulations that provide for release of a compound or composition, for example, by degradation, light release or release with lack of light, or moisture are also provided for.

The disclosure also provides for a composition with a coating as follows:
(1) an outside rapid release coating with a first insect repelling, controlling, or directing compound or composition described herein; and
(2) at least one inner extended or controlled release coating with a second insect repelling, controlling, or directing compound or composition described herein.

The disclosure also provides for a composition with a coating as follows:
(1) an outside controlled release coating with a first insect repelling, controlling, or directing compound or composition described herein; and
(2) at least one inner extended or controlled release coating with a second insect repelling, controlling, or directing compound or composition described herein.

### Mite Repelling or Killing Compound or Composition

In an aspect, a composition described herein can include a compound capable of controlling or killing a mite. In an aspect, a compound capable of controlling or killing a mite is selected from the group consisting of 1-arylimidazoles, 1-aryl pyrroles, and 1-arylpyrazoles.

In another aspect, a compound capable of controlling or killing a mite is selected from the group consisting of Formulas X-XII:

[chemical structure]

wherein,
X is halogen, Cl, F, Br, or I;
A₁, A₂, and A₃ are individually selected from halogen, Cl, F, Br, I, alkyl, or haloalkyl;
Z is H, CN, halogen, or alkylcarbonyl,
n is 0, 1, or 2, and
Y is alkyl, methyl, haloalkyl, perhaloalkyl, polyhaloalkyl, CF2Cl, CF3, or CCl2F.

In another aspect, compounds of Formulas X-XII can be used together with a compound or composition described herein in the methodology described herein.

Composition or Support Treated with a Compound or Composition Described Herein

In an aspect, the disclosure provides for a support or carrier material combined with a compound or composition described herein. In another aspect, the support material can be coated or impregnated with a compound or composition described herein. An insecticide, herbicide, fungicide, or miticide can also be added to the support material coated or impregnated with a compound or composition described herein. Examples of support materials capable of being used with compounds described herein include an absorbent material, wood, cardboard, corrugated cardboard, cotton, wallpaper, paper, plastic, a plastic tube, and metal. Support materials with a low heat transfer rate may also be suitable.

### Kit

In another aspect, the disclosure provides for a kit comprising, consisting essentially of, or consisting of any of the compounds or compositions disclosed herein. In an aspect, the kit includes any of the combination of compounds or compositions described in Examples 1-5, Tables 1-6, or FIGS. 1-6. In another aspect, the kit provides for the compositions described in Examples 1-5, Table 1-6, or FIGS. 1-6, applied in a manner that is consistent with the methodology of these examples and figures. In another aspect, the kit provides instructions or guidance regarding the use of the compositions or methods described herein.

In an aspect, the kit includes instructions describing the methodology described herein. In another aspect, the kit includes instructions describing the methodology set forth in any of Examples 1-5, Tables 1-6, or FIGS. 1-6. In an aspect, the instructions are included with the kit, separate from the kit, in the kit, or are included on the kit packaging.

In another aspect, a repellent, controlling, or directing compound or composition disclosed herein is incorporated into a device or support. In another aspect, a device can include a device designed to house and/or shelter a repelling, controlling, or directing compound or composition disclosed herein. In yet another aspect, a device disclosed herein may be a container, holder or other solid support onto or into which a repelling, controlling, or directing compound or composition disclosed herein is included. A device disclosed herein may be made from any biological or synthetic material, including, without limitation, paper, filter paper, wood, cork, cotton, plastic, polymer, metal, or glass.

In another aspect, the kit can contain a single-use disposable detection device, bait, support material, or trap. The kit may also contain a reusable multi-use detection device, bait, support material, or trap.

In another aspect, the kit may include a supplement to the detection device, bait, support material, or trap. For example, the supplemental kit may contain an additional bait composition or other supplement to the to the detection device, bait, support material, or trap. In one aspect, the supplemental kit is packaged separate from the detection device, bait, support material, or trap. In another aspect, the supplemental kit is packaged together with the detection device, bait, support material, or trap.

The following examples serve to illustrate certain aspects of the disclosure and are not intended to limit the disclosure.

### EXAMPLES

### Example 1

Example 1 sets forth the feeding station arrangement for the honeybee repulsion experiments described herein.

FIG. 1 describes the feeding station arrangement (A and B) for the honeybee repulsion experiments described herein. As set forth in FIG. 1, panel (A) sets forth the bee cage positions on the left portion of panel (A) with the randomized feeding station positions on the right portion of panel (A). Panel (B) sets forth an alignment of the randomized feeding station positions with a distance of two meters between feeding stations. A total of eight feeding stations were evaluated at a ten meter distance in front of the respective bee hives. The feeding stations were placed two meters apart from one another.

Honeybees were trained to deep feeders (eight positions), each containing a 50% sucrose solution for one day. After the honeybees were trained to each feeder, the 50% sucrose feeder at randomized positions 1-8 was replaced with a shallow feeder containing a combination of repelling compounds and a 50% sucrose solution according to Table 3. In accordance with FIGS. 5 and 6, 2% by weight of Camphor oil (T4), Ajowan oil (T5), Camphor powder (T6), Rosemary oil (T7), and 2-Decanone (T8) in combination with a 50% sucrose treatment were added to feeders on day two. Honeybees in randomized position 8 (2-Decanone) exhibited repellency at 24 hours.

### Example 2

Example 2 describes the effectiveness of various active agents in repelling honeybees.

Table 3 describes active agents evaluated for bee repulsion and their randomized feeding station positions. As described in Table 3, T1 (control), T2 (control), T3 (control), T4 (Camphor oil), T5 (Ajowan oil), T6 (Camphor powder), T7 (Rosemary oil), and T8 (2-Decanone).

TABLE 3

| | | Randomized |
|---|---|---|
| | | position |
| Number | | (feeding station |
| Code | Treatment | number) |
| 1 | C (untreated 50% sucrose) | 6 |
| 2 | C (untreated 50% sucrose) | 7 |
| 3 | C (untreated 50% sucrose) | 1 |
| 4 | Camphor oil 2.18 g/100.4 g with 50% sucrose | 4 |
| 5 | Ajowan oil 3.25 g/101.1 g with 50% sucrose | |
| 6 | Camphor powder diluted to 100 fluid g | 5 |
| | with 50% sucrose | |
| 7 | Rosemary oil 2.09 g/114 g 1 g with 50% sucrose | 3 |
| 8 | 2-Decanone 8.6 g/111.83 g 1 g with 50% sucrose | 8 |

FIG. 5 evaluates the number of bees visiting a respective feed station over a time interval. FIG. 6 sets forth the mean number of honeybees visiting feeding station over a period of four hours. 2-decanone was highly repellent for the full 4 hour assessment period and was still repellent after 24 hours. Rosemary oil exhibited initial repellency, but this repellency was not fully maintained for the full 4 hour assessment period

### Example 3

Example 3 sets forth the stability of Poncho with an insect repellent, Eugenol.

Table 4 describes a stability test with a combination of Eugenol and Poncho evaluated at room temperature, 40° C., and 54° C. at zero time, 3 days, and 7 days as confirmed by high performance liquid chromatography (HPLC). As described in Table 4, the content of clothianidin, which is the active agent in Poncho, exhibited chemical stability when combined with an insect and bee repellent Eugenol for up to 54° C. for seven days.

TABLE 4

| Clothianidin content | zero time | after 3 days | after 7 days |
|---|---|---|---|
| Room Temperature | | | |
| Poncho 600 only | 46.30% | 43.88% | 45.19% |
| Poncho 600 + Eugenol at .0053 | 46.25% | 44.48% | 46.02% |
| mg/ml | | | |
| Poncho 600 + Eugenol at .0372 | 43.36% | 35.90% | 41.72% |
| mg/ml | | | |
| 40° C. | | | |
| Poncho 600 only | 46.30% | 44.60% | 44.93% |
| Poncho 600 + Eugenol at .0065 | 46.25% | 44.10% | 44.48% |
| mg/ml | | | |
| Poncho 600 + Eugenol at .0086 | 43.36% | 40.01% | 40.23% |
| mg/ml | | | |
| 54° C. | | | |
| Poncho 600 only | 46.30% | 45.16% | 45.19% |
| Poncho 600 + Eugenol at .0029 | 46.25% | 43.80% | 43.41% |
| mg/ml | | | |
| Poncho 600 + Eugenol at .0203 | 43.36% | 42.53% | 40.65% |
| mg/ml | | | |

### Example 4

Example 4 sets forth the stability of Poncho with an insect repellent, α-terpineol.

Table 5 describes a stability test with a combination of α-terpineol and Poncho 600 evaluated at room temperature, 40° C., and 54° C. at zero time, 2 days, and 8 days as confirmed by HPLC. As described in Table 5, the content of clothianidin, which is the active agent in Poncho, exhibited chemical stability when combined with an insect and bee repellent alpha-terpineol for up to 54° C. for eight days.

TABLE 5

| Clothianidin content | zero time | after 2 days | after 8 days |
|---|---|---|---|
| Room Temperature | | | |
| Poncho 600 only | 45.31% | 46.51% | 55.33% |
| Poncho 600 + α-terpineol at .4173 | 45.45% | 44.62% | 53.62% |
| mg/ml | | | |
| Poncho 600 + α-terpineol at .3600 | 45.29% | 45.32% | 45.07% |
| mg/ml | | | |
| 40° C. | | | |
| Poncho 600 + α-terpineol at .3659 | 45.45% | 44.97% | 45.27% |
| mg/ml | | | |
| Poncho 600 + α-terpineol at ..3981 | 45.29% | 44.83% | 45.37% |
| mg/ml | | | |
| 54° C. | | | |
| Poncho 600 + α-terpineol at .4004 | 45.45% | 46.65% | 48.18% |
| mg/ml | | | |
| Poncho 600 + α-terpineol at .3276 | 45.29% | 46.81% | 50.65% |
| mg/ml | | | |

### Example 5

Example 5 sets forth the stability of Gaucho with an insect repellent, α-terpineol.

Table 6 describes a stability test with a combination of α-terpineol and Gaucho evaluated at room temperature, 40° C., and 54° C. at zero time, 2 days, and 8 days as confirmed by high performance liquid chromatography (HPLC). As described in Table 6, the content of imidacloprid, which is the active agent in Gaucho, exhibited chemical stability when combined with an insect and bee repellent α-terpineol for up to 54° C. for eight days.

TABLE 6

| Imidacloprid content | zero time | after 2 days | after 8 days |
|---|---|---|---|
| Room Temperature | | | |
| Gaucho 600 only | 47.43% | 47.96% | 51.21% |
| Gaucho 600 + α-terpineol at .3745 | 48.59% | 47.72% | 48.21% |
| mg/ml | | | |
| Gaucho 600 + α-terpineol at .4594 | 48.19% | 48.85% | 47.89% |
| mg/ml | | | |
| 40° C. | | | |
| Gaucho 600 + α-terpineol at .4140 | 48.59% | 47.66% | 48.61% |
| mg/ml | | | |
| Gaucho 600 + α-terpineol at .5787 | 48.19% | 48.98% | 49.32% |
| mg/ml | | | |
| 54° C. | | | |
| Gaucho 600 + α-terpineol at .4154 | 48.59% | 48.82% | 50.51% |
| mg/ml | | | |
| Gaucho 600 + α-terpineol at .4392 | 48.19% | 49.32% | 53.16% |
| mg/ml | | | |

1. A method for repelling or directing an insect away from a structure, article, and/or organism, comprising
a) treating the structure, article, and/or organism with one or more of a compounds of Formula (I)-(IX) selected from the group consisting of: [chemical structure]
in which,
R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl, alkyl substituted with halogen, F, Cl, Br, I, oxygen, hydroxyl, alkoxy, cyano, aryloxy, C═C, C≡C; nitrogen, NH2, alkyl amino, dialkyl amine trialkylamino; SH, alkylthio or where R¹ and R² are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, (CH₂)₁₃ ring structure;
R₃ and R₄ are individually selected from H, alkyl, methyl, ethyl, propyl, or butyl;
b) wherein said one or more compounds repels or directs at least 80% of the insects away from said structure, article, and/or organism for at least 8 hours.

2. The method according to claim 1, wherein R₁ is methyl or ethyl and R₂ is selected from the group consisting of methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl.

3. The method according to claim 1, wherein said one or more compounds is a C₇-C₁₅ ketone.

4. The method according to claim 3, wherein said C₇-C₁₅ ketone is selected from the group consisting of 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

5. The method according to claim 1, wherein said insect is a pollinating insect and said pollinating insect is optionally a honeybee.

6. The method according to claim 1, wherein said one or more compounds repels or directs at least 95% of the insects away from said structure, article, and/or organism for at least 24 hours.

7. The method according to claim 1, wherein said one or more compounds is formulated in a composition comprising an agent selected from the group consisting of camphor, camphor oil, camphor powder, tea tree oil, pine oil, rosemary powder, rosemary oil, and rosemary powder.

8. The method according to claim 3, wherein said C₇-C₁₅ ketone compound repels or directs a larger percentage of insects than an equal percent weight of a compound selected from the group consisting of camphor oil, ajowan oil, camphor powder, and rosemary oil.

9. The method according to claim 1, wherein said structure is selected from the group consisting of a commercial or residential building, the interior or exterior of a commercial or residential building, a house, a car, a boat, a patio, a deck, furniture, a window, a container, a container designed to hold an insect, a container designed to repel, direct, or control an insect, a trashcan or trash receptacle, an indoor space, an outdoor space, a tree, a bush, a lawn, a shed, a clover, a shrub, a flowering plant, and additional structure capable of being contacted or infested by an insect.

10. The method according to claim 1, wherein said article is selected from the group consisting of a bait, bait mechanism or holder, garment, belt, air freshener, candle, fiber, bedding, sheet, cloth, clothing, a net, insect netting, fabric, paper, glass, paint, ink, clay, cotton, wood, furniture, carpet, plastic, polymer, biological or synthetic material, spray product, fogging system, foam, gel, evaporator product, granule, and dust.

11. A bait composition comprising
a) one or more compounds of Formula (I)-(IX) selected from the group consisting of: [chemical structure]
in which,
R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non-substituted C₂-C₁₄-alkyl, substituted or non-substituted C₂-C₁₄ alkenyl, a substituted or non-substituted C₂-C₁₄-alkynyl, alkyl substituted with halogen, F, Cl, Br, I, oxygen, hydroxyl, alkoxy, cyano, aryloxy, C═C, C≡C; nitrogen, NH2, alkyl amino, dialkyl amine trialkylamino; SH, alkylthio or where R¹ and R² are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, (CH₂)₁₃ ring structure;
R₃ and R₄ are individually selected from H, alkyl, methyl, ethyl, propyl, or butyl;
b) an agent selected from the group consisting of camphor oil, ajowan oil, camphor powder, and rosemary oil; and
c) wherein said bait composition repels or directs at least 80% of a targeted insect away from a targeted structure, article, and/or organism for at least 8 hours.

12. The bait composition according to claim 11, wherein said one or more compounds comprises a C₇-C₁₅ ketone.

13. The bait composition according to claim 12, wherein said C₇-C₁₅ compound is selected from the group consisting of 3-heptanone, 4-heptanone, cycloheptanone, 2-octanone, 3-octanone, cyclooctanone, 2-nonanone, cyclononanone, 2-decanone, 3-decanone, 4-decanone, 5-decanone, 2-undecanone, 2-dodecanone, 2-trideconone, 2-tetradecanone, 2-pentadecanone, 2-hexadecanone, 2-heptadecanone, cyclodeconone, and sulfur analogs of 2-decanone.

14. The bait composition according to claim 11, wherein said insect is a pollinating insect and optionally a honeybee.

15. The bait composition according to claim 11, wherein said bait composition repels or directs at least 95% of the insects for at least 8 hours.

16. The bait composition according to claim 11, wherein said bait composition comprises
(a) a C₇-C₁₅ ketone, and
(b) camphor oil, camphor powder, rosemary powder, and/or rosemary oil.

17. The bait composition according to claim 12, wherein said C₇-C₁₅ ketone compound repels, controls, or directs a larger percentage of insects than a composition comprising a compound selected from the group consisting of camphor oil, ajowan oil, camphor powder, and rosemary oil.

18. The bait composition according to claim 11, wherein said bait composition is formulated in a controlled released composition, delayed release composition, rapid release composition, and combinations thereof.

19. The bait composition according to claim 11, wherein said composition further comprises a treating agent selected from the group consisting of an insecticide, fungicide, pesticide, and miticide.

20. The method of claim 19, wherein said miticide is selected from the group consisting of 1-arylimidazole, 1-aryl pyrrole, and 1-arylpyrazole.

21. A structure or article capable of repelling, controlling, or directing an insect from the structure or article, wherein the structure or article is treated with one or more of a compound of Formula (I)-(IX) selected from the group consisting of: [chemical structure]
in which,
R₁ and R₂ are independently selected from methyl, ethyl, propyl, isopropyl, cyclopropyl, butyl, iso-butyl, tert-butyl, pentyl, hexyl, heptyl, octyl, nonyl, decyl, undecyl and substituted or non substituted C₂-C₁₄-alkyl, substituted or non substituted C₂-C₁₄ alkenyl, a substituted or non substituted C₂-C₁₄-alkynyl, alkyl substituted with halogen, F, Cl, Br, I, oxygen, hydroxyl, alkoxy, cyano, aryloxy, C═C, C≡C; nitrogen, NH2, alkyl amino, dialkyl amine trialkylamino; SH, alkylthio or where R¹ and R² are linked together to form a substituted or unsubstituted (CH₂)₃, (CH₂)₄, (CH₂)₅, (CH₂)₆, (CH₂)₇, (CH₂)₈, (CH₂)₉, (CH₂)₁₀, (CH₂)₁₁, (CH₂)₁₂, (CH₂)₁₃ ring structure; and
R₃ and R₄ are individually selected from H, alkyl, methyl, ethyl, propyl, or butyl; and
wherein the structure or article repels, controls, or directs at least 80% of a targeted insect away from the structure or article for at least 8 hours.
